(19) United States
(12) Patent Application Publication
(10) Pub. No.: US 2009/0174851 A1
(43) Pub. Date: Jul. 9, 2009

(54) LIQUID CRYSTAL DISPLAY PANEL AND MANUFACTURING METHOD THEREOF

(75) Inventors: Szu-Fen Chen, Taoyuan (TW); Huang-Ming Chen, Hsinchu County (TW); Wei-Ching Wu, Yilan County (TW); Han-Ping D. Shieh, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taipei (TW)

(21) Appl. No.: 12/168,072

(22) Filed: Jul. 4, 2008

(30) Foreign Application Priority Data
Jan. 4, 2008 (TW) 97100340

(51) Int. Cl. G02F 1/1337; G02F 1/1333

(52) U.S. Cl. 349/128; 349/187; 430/20

(57) ABSTRACT

An optically self-compensated birefringence liquid crystal display (OCB-LCD) panel including a first substrate, a first splay aligned layer, a second substrate and an OCB liquid crystal layer is provided. A first alignment layer is disposed on a surface of the first substrate. The first splay aligned layer is disposed on a surface of the first alignment layer, and the material of the first splay aligned layer includes a polymer polymerized by a first reactive mesogen (RM) monomer. The second substrate is disposed opposite to the first substrate, and a second alignment layer is disposed on a surface of the second substrate. The OCB liquid crystal layer is interposed between the first substrate and the second substrate.

### CROSS-REFERENCE TO RELATED APPLICATION

This application claims the priority benefit of Taiwan application serial no. 97100340, filed on Jan. 4, 2008. The entirety of the above-mentioned patent application is hereby incorporated by reference herein and made a part of specification.

### BACKGROUND OF THE INVENTION

1. Field of the Invention

The present invention relates to a liquid crystal display (LCD) panel and a manufacturing method thereof. More particularly, the present invention relates to an optically self-compensated birefringence liquid crystal display (OCB-LCD) panel and a manufacturing method thereof.

2. Description of Related Art

LCD panels are categorized into various types in accordance with different liquid crystals, driving methods and light source arrangements. Among the LCD panels, an optically self-compensated birefringence liquid crystal display (OCB-LCD) panel featuring prompt response time is able to provide smooth image presentation while frames of animations or movies are changed in a continuous and rapid manner. However, only after all liquid crystal molecules are transited from a splay state into a bend state, the OCB-LCD panel can be in a standby status for providing speedy operations. That is to say, the OCB-LCD panel requires relatively longer warm-up time than the others. A process of transiting the splay state to the bend state is often referred to as a phase transition.

In order to transforming the liquid crystal molecules from the splay state into the bend state, many technologies have been developed continually in the recent years according to the pertinent art. For instance, according to the disclosure of San Hwa KIM and Liang-Chy CHIEN in Jpn. J. Appl. Phys., 43, 7643 (2004), substances which can be radiated and polymerized are added into the liquid crystals, and then voltages are applied to the liquid crystal molecules for arranging the same in the bend alignment. Thereafter, ultraviolet (UV) light is applied to the liquid crystal molecules, so as to form a polymer network in a crystal cell. In an alternative, a non-transparent region of a substrate, i.e. a black matrix (BM) of the LCD panel is irradiated, so as to polymerize molecules and to thereby form a polymer wall. As such, the liquid crystal molecules equipped with the BM are always configured in the bend state due to an impact of the polymerized molecules, as provided by H. Kikuchi et al., in Jpn. J. Appl. Phys., 44, 981 (2005). It is also likely to obtain a bend transition core by different pre-tilt angles. Since it is more flexible for the liquid crystal molecules to be arranged in the bend state than in the splay state in a high pre-tilt angle area, the liquid crystal molecules are directly arranged in the bend alignment without applying external voltages thereto, as proposed by M. Xu, D. K. Yang, and P. J. Bos in SID Dig., 11.4L (1998). Various methods can be applied to form the high pre-tilt angle area, such as implementing an ion-beam alignment method taught by S. H. Lee, T. J. Kim, G. D. Lee, T. H. Yoon, and J. C. Kim in Jpn. J. Appl. Phys., 42, L1148 (2001). Moreover, as disclosed by F. S. Y Yeung, F. C. Xie, and H. S. Kwok in SID Dig., 23.2 (2005), two alignment materials with different pre-tilt angles can be mixed, so as to form alignment layers of nano-structure and thereby to obtain the bend transition core. Further, a vertical alignment of molecules is carried out on a portion of a substrate of the cell for forming a hybric-aligned-nematic (HAN) structure as the bend transition core, so as to enable a rapid transition in accordance with the teaching provided by E. Acosta et al., in Liquid Crystal, 31, 1619 (2004).

Nevertheless, the above-identified conventional technologies all require the fabrication of the bend transition core in the non-transparent region of a pixel. Thereby, the phase transition starts from peripheries of the pixel to a center thereof. Said phase transition, however, may be incomplete. On the other hand, as the aforesaid technologies are applied to mass production, a great number of existing manufacturing processes must be correspondingly adjusted.

### SUMMARY OF THE INVENTION

The present invention is directed to an OCB-LCD panel which is an OCB-LCD panel without applying phase transition voltage.

The present invention is further directed to a manufacturing method of an OCB-LCD panel. Said manufacturing method is capable of fabricating a liquid crystal layer with a high pre-tilt angle. Thereby, liquid crystal molecules are directly in a bend state, and the phase transition voltage is not required.

The present invention provides an OCB-LCD panel including a first substrate, a first splay aligned layer, a second substrate and an OCB liquid crystal layer. A first alignment layer is disposed on a surface of the first substrate. The first splay aligned layer is disposed on a surface of the first alignment layer, and the material of the first splay aligned layer includes a polymer polymerized by a first reactive mesogen (RM) monomer. The second substrate is disposed opposite to the first substrate, and a second alignment layer is disposed on a surface of the second substrate. The OCB liquid crystal layer is interposed between the first substrate and the second substrate.

According to an embodiment of the present invention, the first RM monomer includes a cholesteric liquid crystal monomer.

According to an embodiment of the present invention, the OCB-LCD panel further includes a second splay aligned layer. The second splay aligned layer is disposed on a surface of the second alignment layer, and the material of the second splay aligned layer includes a polymer polymerized by a second RM monomer.

According to an embodiment of the present invention, the second RM monomer includes a cholesteric liquid crystal monomer.

According to an embodiment of the present invention, one of the first substrate and the second substrate is an active device array substrate, while the other is a color filter substrate.

According to an embodiment of the present invention, the OCB-LCD panel further includes a first polarizer and a second polarizer. The first polarizer is disposed on another surface of the first substrate. The second polarizer is disposed on another surface of the second substrate.

According to an embodiment of the present invention, the OCB-LCD panel further includes a first optical compensation film and a second optical compensation film. The first optical compensation film is disposed between the first polarizer and another surface of the first substrate. The second optical compensation film is disposed between the second polarizer and another surface of the second substrate.

The present invention further provides a manufacturing method of an OCB-LCD panel. The manufacturing method includes a step of providing a first substrate on a surface of which a first alignment layer is formed. A first RM monomer layer is then formed on a surface of the first alignment layer. A first curing process is performed for polymerizing the first RM monomer layer, so as to form a first splay aligned layer. Next, a second substrate is provided, and a second alignment layer is formed on a surface of the second substrate. The first substrate and the second substrate are assembled together. Meanwhile, an OCB liquid crystal layer is filled between the first substrate and the second substrate.

According to another embodiment of the present invention, the first RM monomer includes a cholesteric liquid crystal monomer.

According to another embodiment of the present invention, the first curing process includes applying UV light.

According to another embodiment of the present invention, in the manufacturing method of the OCB-LCD panel, the method of forming the first RM monomer layer on the first alignment layer includes performing a spin-coating process, a screen printing process, or an ink-jet printing process.

According to another embodiment of the present invention, the manufacturing method of the OCB-LCD panel further includes forming a second RM monomer layer on a surface of the second alignment layer. A second curing process is then implemented for polymerizing the second RM monomer layer, so as to form a second splay aligned layer.

According to another embodiment of the present invention, the second RM monomer includes a cholesteric liquid crystal monomer.

According to another embodiment of the present invention, the second curing process includes applying UV light.

According to another embodiment of the present invention, in the manufacturing method of the OCB-LCD panel, the method of forming the second RM monomer layer on the second alignment layer includes performing a spin-coating process, a screen printing process, or an ink-jet printing process.

According to another embodiment of the present invention, one of the first substrate and the second substrate is an active device array substrate, while the other is a color filter substrate.

According to another embodiment of the present invention, the manufacturing method of the OCB-LCD panel further includes forming a first polarizer on another surface of the first substrate and forming a second polarizer on another surface of the second substrate.

According to another embodiment of the present invention, the manufacturing method of the OCB-LCD panel further includes forming a first optical compensation film between the first polarizer and another surface of the first substrate and forming a second optical compensation film between the second polarizer and another surface of the second substrate.

In light of the foregoing, through disposing the splay aligned layers polymerized from the RM monomers on the surfaces of the alignment layers, the LCD panel of the present invention enables the liquid crystal molecules to be arranged in the bend state without applying the phase transition voltages. Moreover, in comparison with the conventional technologies, the manufacturing method of the present invention does not require significant changes in the existing processes of manufacturing the LCD panel.

In order to the make the aforementioned and other objects, features and advantages of the present invention comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a partial cross-sectional view schematically illustrating an LCD panel according to the present invention.

FIG. 2 is a partial cross-sectional view schematically illustrating another LCD panel according to the present invention.

FIGS. 3A through 3C illustrate a manufacturing method of an OCB-LCD panel according to the present invention.

### DESCRIPTION OF EMBODIMENTS

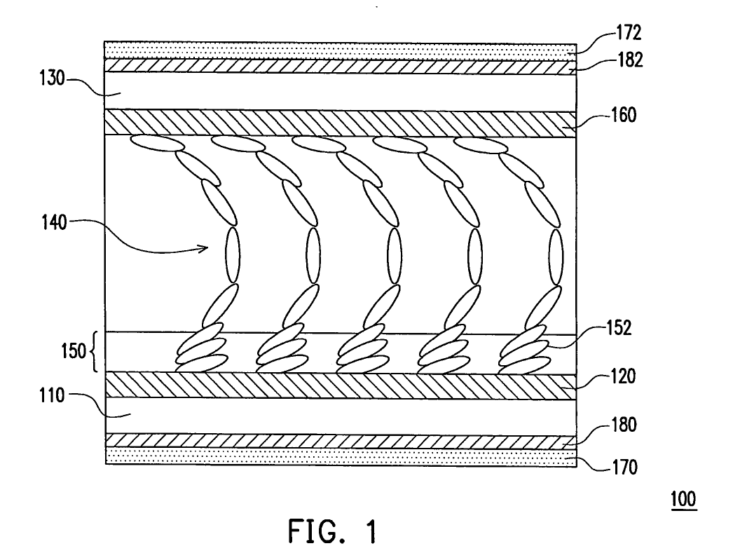

FIG. 1 is a partial cross-sectional view schematically illustrating an LCD panel according to the present invention. Referring to FIG. 1, an LCD panel 100 includes a first substrate 110, a first splay aligned layer 150, a second substrate 130, and an OCB liquid crystal layer 140. The OCB liquid crystal layer 140 is interposed between the first substrate 110 and the second substrate 130.

A first alignment layer 120 and the first splay aligned layer 150 are disposed over a surface of the first substrate 110. Herein, the first alignment layer 120 is formed on the surface of the first substrate 110, while the first splay aligned layer 150 is then formed on a surface of the first alignment layer 120. Note that the material of the first splay aligned layer 150 includes a polymer polymerized from a first reactive mesogen (RM) monomer 152 which is, for example, a cholesteric liquid crystal monomer. In one embodiment, a first polarizer 170 and a first optical compensation film 180 are further disposed on another surface of the first substrate 110. Herein, the first optical compensation film 180 is disposed on another surface of the first substrate 110, while the first polarizer 170 is disposed on the first optical compensation film 180.

On the other hand, the second substrate 130 is disposed opposite to the first substrate 110, and a second alignment layer 160 is formed on a surface of the second substrate 130. In one embodiment, a second polarizer 172 and a second optical compensation film 182 are further disposed over another surface of the second substrate 130. Herein, the second optical compensation film 182 is disposed on another surface of the second substrate 130, while the second polarizer 172 is disposed on the second optical compensation film 182.

Note that one of the first substrate 110 and the second substrate 130 is, for example, an active device array substrate, while the other is, for example, a color filter substrate. The present embodiment is elaborated on the condition that the first substrate 110 is the color filter substrate, whereas the second substrate 130 is the active device array substrate. In detail, a color filter film (not shown) is formed on the first substrate 110. The color filter film includes, for example, a display region with a plurality of color filter units and a non-display region with a BM. On the contrary, an active layer (not shown) is formed on the second substrate 130. The active layer has a plurality of scan lines, a plurality of data lines, a plurality of thin film transistors (TFTs), and a plurality of pixel electrodes. Each of the TFTs is electrically connected to the corresponding scan line and the corresponding data line. Each of the pixel electrodes is electrically connected to the corresponding TFT.

In the present embodiment, the first RM monomer 152 is coated onto the first alignment layer 120 for forming the first splay aligned layer 150 in which liquid crystal molecules are constantly arranged in a splay state. Therefore, since a pre-tilt angle of the OCB liquid crystal layer 140 can be expanded by the first splay aligned layer 150, when the OCB liquid crystal layer 140 is formed onto the first splay aligned layer 150, the OCB liquid crystal layer 140 appears to be in a bend state without applying phase transition voltages. On the other hand, the first splay aligned layer 150 is not only able to increase the pre-tilt angle of the OCB liquid crystal layer 140, but also capable of changing anchoring energy. Hence, as driving voltages of the LCD panel 100 of the present invention are applied at a black state, the liquid crystal molecules of the OCB liquid crystal layer 140 are all vertical to the surface of the substrate. Thereby, residual optical retardation is reduced, and image contrast of the LCD panel 100 is further improved.

Besides, the first RM monomer 152 is characterized by favorable birefringence and intrinsic optical retardation. Accordingly, the first RM monomer 152 is often utilized as the optical compensation film. In the present invention, the use of the first RM monomer 152 ensures the high pre-tilt angle of the OCB liquid crystal layer 140 and results in optical compensation. As a result, when the first RM monomer 152 is intended to be used, the optical retardation obtained therefrom and the optical retardation of the first optical compensation film 180 and the second optical compensation film 182 should be taken into account together.

In the aforesaid embodiment, the first splay aligned layer 150 is formed on the first alignment layer 120 on the first substrate 110. However, said position of the first splay aligned layer 150 is merely exemplary and no limitation is posed on the position of the first splay aligned layer 150 in the present invention. Namely, the first splay aligned layer 150 can also be formed on the second alignment layer 160 on the second substrate 130.

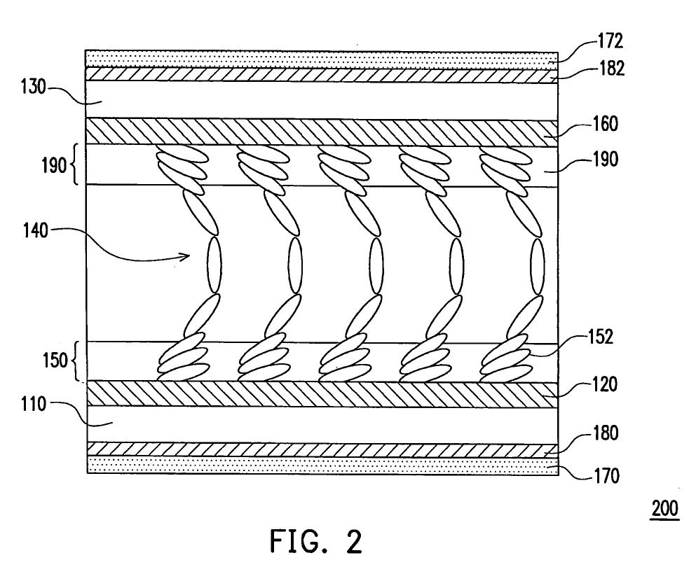

FIG. 2 is a partial cross-sectional view schematically illustrating another LCD panel according to the present invention. Referring to FIG. 2, an LCD panel 200 and the LCD panel 100 have similar structures, while the difference therebetween lies in that not only forming the first splay aligned layer 150 on the first alignment layer 120, but also forming a second splay aligned layer 190 on the second alignment layer 160. The material of the second splay aligned layer 190 and the method for forming the same are the same or similar to that of the first splay aligned layer 150. In other words, in this embodiment, the splay aligned layers are disposed on both of the two substrates. The LCD panel 200 equipped with said structure can maintain the wide-viewing-angle optical self-compensation during image display in comparison with the LCD panel 100. That is to say, the LCD panel 200 achieves a relatively satisfactory wide viewing angle effect. In addition, the optical retardation obtained from the first splay aligned layer 150 disposed on the first substrate 110 and the second splay aligned layer 190 disposed on the second substrate 130 should be taken into account as well. Namely, compensation values of the first optical compensation film 180 and the second optical compensation film 182 must be re-adjusted.

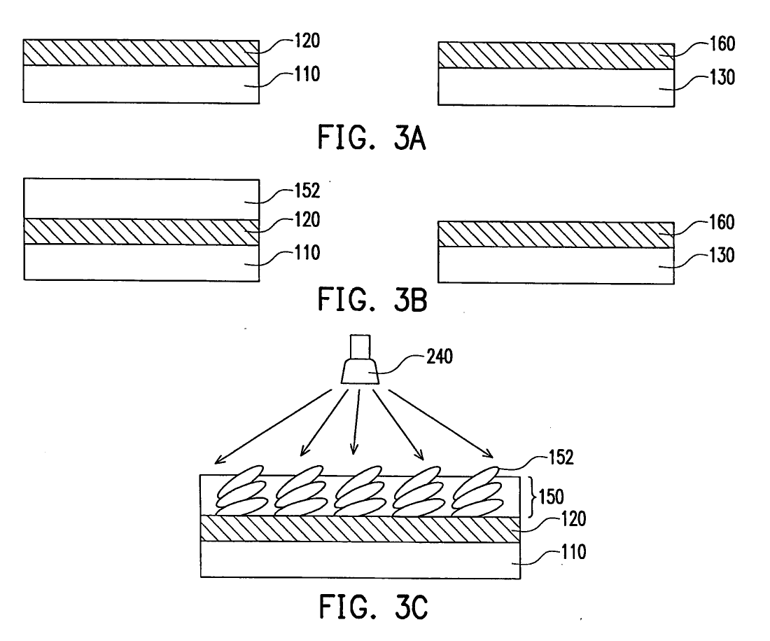

FIGS. 3A through 3C illustrate a manufacturing method of an OCB-LCD panel according to the present invention. Referring to FIG. 3A, a first substrate 110 and a second substrate 130 are provided at first. Besides, a first alignment layer 120 and a second alignment layer 160 are respectively formed on a surface of the first substrate 110 and on a surface of the second substrate 130. The method of forming the first alignment layer 120 and the second alignment layer 160 includes conducting a screen printing at first, for example. A thermal curing process is then carried out, and finally a rubbing treatment is conducted.

Next, referring to FIG. 3B, a first RM monomer 152 is coated onto the first alignment layer 120. Here, the first RM monomer 152 can be a cholesteric liquid crystal monomer, and the coating process may include a spin coating, a screen printing, or an ink-jet printing.

Thereafter, referring to FIG. 3C, a first curing process is performed on the first substrate 110 which is already coated with the first RM monomer 152. For example, an UV light 240 is applied to the first RM monomer 152, so as to polymerize the same and thereby to form a first splay aligned layer 150.

After that, the first substrate 110 depicted in FIG. 3C and the second substrate 130 illustrated in FIG. 3B are assembled, and an OCB liquid crystal layer 140 is filled between the first substrate 110 and the second substrate 130, so as to form the LCD panel as indicated in FIG. 1. In one embodiment, the method of filling the OCB liquid crystal layer 140 includes a vacuum filling method or a one drop filling (ODF) method. For example, in the vacuum filling method, a sealant (not shown) is employed to adhere the first substrate 110 to the second substrate 130. Besides, the pressure between the first substrate 110 and the second substrate 130 is less than an external pressure, and thereby liquid crystal molecules can be filled between the two substrates 110 and 130. By contrast, through the implementation of the ODF method, the liquid crystal molecules are dropped onto the first substrate 110 or the second substrate 130 before the first and the second substrates 110 and 130 are assembled. Here, the sealant (not shown) is already applied to the first or the second substrates 110 and 130. After that, the first substrate 110 and the second substrate 130 are adhered to each other by the sealant (not shown).

After the implementation of the above processes, the fabrication of the LCD panel 100 is approximately completed. It should be mentioned that the first splay aligned layer 150 formed in the LCD panel 100 of the present invention is characterized by intrinsic optical retardation. Hence, when the first optical compensation film 180 and the second optical compensation film 182 are additionally disposed in the LCD panel 100, the optical retardation obtained therefrom ought to be taken into account as well.

The manufacturing processes of the LCD panel 200 as shown in FIG. 2 are similar to those depicted in FIGS. 3A through 3C. The difference therebetween lies in that the second splay aligned layer 190 is coated onto the second alignment layer 160 aside from the formation of the second alignment layer 160 on a surface of the second substrate 130 in the LCD panel 200 depicted in FIG. 2. In addition to the above, the materials and the manufacturing methods of the second alignment layer 160 and the second splay aligned layer 190 are similar or identical to those of the first alignment layer 120 and the first splay aligned layer 150. According to the embodiment illustrated in FIG. 2, the first splay aligned layer 150 and the second splay aligned layer 190 are respectively formed on the first substrate 110 and on the second substrate 130 of the LCD panel 200. Besides, note that the first splay aligned layer 150 and the second splay aligned layer 190 in the LCD panel 200 are characterized by intrinsic optical retardation. Hence, when the first optical compensation film 180 and the second optical compensation film 182 are additionally disposed in the LCD panel 200, the optical retardation obtained therefrom ought to be taken into account as well. What is more, the thickness of the first splay aligned layer 150 and the second splay aligned layer 190 is substantially equal to or less than 1 μm.

To sum up, the OCB-LCD panel of present invention has at least following advantages. First, the disposition of the first splay aligned layer in the LCD panel enables the liquid crystal molecules in the OCB liquid crystal layer to be directly arranged in the bend state without applying the phase transition voltage. Moreover, the manufacturing method of the present invention is able to accomplish the phase transition of the liquid crystal molecules without changing the existing process of manufacturing the LCD panel. Furthermore, the anchoring energy is reduced in the present invention, and thus the contrast of the LCD panel of the present invention can then be enhanced.

Although the present invention has been disclosed above by the embodiments, they are not intended to limit the present invention. Anybody skilled in the art can make some modifications and alteration without departing from the spirit and scope of the present invention. Therefore, the protecting range of the present invention falls in the appended claims.

What is claimed is:

1. An optically self-compensated birefringence liquid crystal display panel, comprising:
a first substrate, comprising a first alignment layer on a surface of the first substrate;
a first splay aligned layer disposed on a surface of the first alignment layer, wherein the material of the first splay aligned layer comprises a polymer polymerized by a first reactive mesogen monomer;
a second substrate disposed opposite to the first substrate and comprising a second alignment layer on a surface of the second substrate; and
an OCB liquid crystal layer interposed between the first substrate and the second substrate.

2. The optically self-compensated birefringence liquid crystal display panel as claimed in claim 1, wherein the first reactive mesogen monomer comprises a cholesteric liquid crystal monomer.

3. The optically self-compensated birefringence liquid crystal display panel as claimed in claim 1, further comprising a second splay aligned layer disposed on a surface of the second alignment layer, wherein the material of the second splay aligned layer comprises a polymer polymerized by a second reactive mesogen monomer.

4. The optically self-compensated birefringence liquid crystal display panel as claimed in claim 3, wherein the second reactive mesogen monomer comprises a cholesteric liquid crystal monomer.

5. The optically self-compensated birefringence liquid crystal display panel as claimed in claim 1, wherein one of the first substrate and the second substrate is an active device array substrate, while the other is a color filter substrate.

6. The optically self-compensated birefringence liquid crystal display panel as claimed in claim 1, further comprising:
a first polarizer disposed on another surface of the first substrate; and
a second polarizer disposed on another surface of the second substrate.

7. The optically self-compensated birefringence liquid crystal display panel as claimed in claim 6, further comprising:
a first optical compensation film disposed between the first polarizer and another surface of the first substrate; and
a second optical compensation film disposed between the second polarizer and another surface of the second substrate.

8. A manufacturing method of an optically self-compensated birefringence liquid crystal display panel, the manufacturing method comprising:
providing a first substrate;
forming a first alignment layer on a surface of the first substrate;
forming a first reactive mesogen monomer layer on a surface of the first alignment layer;
performing a first curing process for polymerizing the first reactive mesogen monomer layer, so as to form a first splay aligned layer;
providing a second substrate;
forming a second alignment layer on a surface of the second substrate; and
assembling the first substrate and the second substrate and filling an OCB liquid crystal layer between the first substrate and the second substrate.

9. The manufacturing method as claimed in claim 8, wherein the first reactive mesogen monomer comprises a cholesteric liquid crystal monomer.

10. The manufacturing method as claimed in claim 8, wherein the first curing process comprises applying ultraviolet light.

11. The manufacturing method as claimed in claim 8, wherein the method of forming the first reactive mesogen monomer layer on the first alignment layer comprises performing a spin-coating process, a screen printing process, or an ink-jet printing process.

12. The manufacturing method as claimed in claim 8, further comprising:
forming a second reactive mesogen monomer layer on a surface of the second alignment layer; and
performing a second curing process for polymerizing the second reactive mesogen monomer layer, so as to form a second splay aligned layer.

13. The manufacturing method as claimed in claim 12, wherein the second reactive mesogen monomer comprises a cholesteric liquid crystal monomer.

14. The manufacturing method as claimed in claim 12, wherein the second curing process comprises applying UV light.

15. The manufacturing method as claimed in claim 12, wherein the method of forming the second reactive mesogen monomer layer on the second alignment layer comprises performing a spin-coating process, a screen printing process, or an ink-jet printing process.

16. The manufacturing method as claimed in claim 8, wherein one of the first substrate and the second substrate is an active device array substrate, while the other is a color filter substrate.

17. The manufacturing method as claimed in claim 8, further comprising:
forming a first polarizer on another surface of the first substrate; and
forming a second polarizer on another surface of the second substrate.

18. The manufacturing method as claimed in claim 17, further comprising:
forming a first optical compensation film between the first polarizer and another surface of the first substrate; and
forming a second optical compensation film between the second polarizer and another surface of the second substrate.
